(19) United States
(12) Patent Application Publication
(10) Pub. No.: US 2024/0237768 A1
(43) Pub. Date: Jul. 18, 2024

(54) Anti-scratching Safety Cover

(71) Applicants: Michelle Nokeo Twite, Austin, TX (US); Robert Matthew Twite, Austin, TX (US)

(72) Inventors: Michelle Nokeo Twite, Austin, TX (US); Robert Matthew Twite, Austin, TX (US)

(21) Appl. No.: 18/097,527

(22) Filed: Jan. 17, 2023

(51) Int. Cl. A41D 19/015; A41D 11/00; A41D 19/01; A41D 31/30

(52) U.S. Cl. CPC A41D 19/015; A41D 11/00; A41D 19/01; A41D 31/30; A01K 13/007

(57) ABSTRACT

The present disclosure provides a safety cover for the hands or feet of a baby to prevent them scratching themselves and which can be applied and removed easily. The safety cover comprises an elongated elastic cuff ring with a plurality of separate gripping elements arranged on its interior surface such that they span a majority of the length of the inner surface. This design allows the elongated cuff to simply be folded back on itself to disengage the gripping elements from skin contact. When folded, the safety cover can be applied or removed with no effort, and the structure of the cuff ring also causes it to maintain an elastic tension about the wrist or ankle of a child while folded to facilitate use as a normal glove, mitten or sock.

### FIELD OF INVENTION

The present invention relates generally to protective clothing items. More specifically the present invention relates to an anti-scratching safety cover to be worn by a baby or pet to prevent self-scratching.

### BACKGROUND

It is a common problem for parents that, as their baby's nails develop, they begin scratching themselves inadvertently and during their sleep. If left unattended, this tendency can cause significant damage to the sensitive skin of the child and cause them and their parents a great deal of distress. This problem can occur with both the hands and feet of a baby.

In order to address this problem, covers have been developed which are difficult for babies to take off themselves. These covers usually work by having some form of fastening mechanism that a baby will be unable to remove from their extremities unassisted. A problem however is that these fastenings are also inconvenient for the caregiver of the child to remove too. The caregiver has to undo the fastenings carefully one by one, while the baby is often thrashing and trying to move around.

Furthermore, currently available anti-scratching covers do not have the ability to be used as normal gloves, mittens, or socks. The fastenings are either engaged, meaning they are not removable by the baby, or are unengaged and allow the cover to fall off too easily.

There is a need for a cover design for the hands and feet of babies that can be easily applied and removed by a caregiver to prevent the baby from scratching themselves, while also provides the versatility of doubling up as a normal glove/mitten/sock for the child which they can take off themselves if they are uncomfortable.

It is within this context that the present invention is provided.

### SUMMARY

The present disclosure provides a safety cover for the hands or feet of a child to prevent them scratching themselves and which can be applied and removed easily. The safety cover comprises an elongated elastic cuff ring with a plurality of separate gripping elements arranged on its interior surface such that they span a majority of the length of the inner surface. This design allows the elongated cuff to simply be folded back on itself to disengage the gripping elements from skin contact. When folded, the safety cover can be applied or removed with no effort, and the structure of the cuff ring also causes it to maintain an elastic tension about the wrist or ankle of a child while folded to facilitate use as a normal glove, mitten or sock.

According to a first aspect of the present disclosure, there is provided a wearable safety cover, comprising: a cover body formed of a flexible fabric material and having a first open end and a second closed end; an elongated cuff ring coupled to the first open end of the cover body, the cuff ring being formed of an elastic material arranged so as to allow stretching of the cuff ring circumference; and an arrangement of separate gripping elements disposed about the circumference of an interior surface of the elongated cuff ring, the arrangement of gripping elements spanning a majority of the length of the elongated cuff ring.

In some embodiments, the gripping elements are attachments formed of a material having a greater friction coefficient than the material forming the cuff ring. For example, the gripping elements may be silicone attachments.

In some embodiments, the arrangement of gripping elements forms an array with multiple rows of gripping elements spanning the length of the cuff ring interior surface.

In other embodiments, the gripping elements each have an elongated shape oriented such that their lengths are aligned with the length of the elongated cuff ring.

In some embodiments, the arrangement of gripping elements spans the entire circumference of the interior surface of the cuff ring.

In alternative embodiments, the arrangement of gripping elements is divided into two arrangements disposed on opposing portions of the circumference of the interior surface of the cuff ring.

In some embodiments, the cuff ring has been knitted using a circular knitting technique to form a seamless circumference.

In some embodiments, the cuff ring and/or cover body have silver threads woven for an antimicrobial effect.

### BRIEF DESCRIPTION OF THE DRAWINGS

Various embodiments of the invention are disclosed in the following detailed description and accompanying drawings.

FIG. 1 illustrates an isometric perspective view of a first example configuration of a safety cover according to the present disclosure. The position of gripping elements on the interior surface of the cuff ring are shown for clarity in this figure and all subsequent figures.

FIG. 2 illustrates an isometric front view of the first example configuration of the safety cover.

FIG. 3 illustrates an isometric side view of the first example configuration of the safety cover.

FIG. 4 illustrates an isometric view of the opening of the first example configuration of the safety cover.

FIG. 5 illustrates an isometric front view of the first example configuration of the safety cover in a folded state.

FIG. 6 illustrates an isometric perspective view of a second example configuration of the safety cover of the present disclosure with an alternative arrangement of gripping elements.

FIG. 7 illustrates an isometric front view of the second example configuration of the safety cover in a folded state.

FIG. 8 illustrates an isometric perspective view of a third example configuration of the safety cover of the present disclosure with an alternative arrangement of gripping elements.

FIG. 9 illustrates an isometric front view of the third example configuration of the safety cover in a folded state.

FIG. 10 illustrates an isometric side view of a fourth example configuration of the safety cover of the present disclosure with an alternative arrangement of gripping elements.

FIG. 11 illustrates an isometric view of the opening of the fourth example configuration of the safety cover.

FIG. 12 illustrates an isometric front view of the fourth example configuration of the safety cover in a folded state.

Common reference numerals are used throughout the figures and the detailed description to indicate like elements. One skilled in the art will readily recognize that the above figures are examples and that other architectures, modes of operation, orders of operation, and elements/functions can be provided and implemented without departing from the characteristics and features of the invention, as set forth in the claims.

### DETAILED DESCRIPTION AND PREFERRED EMBODIMENT

The following is a detailed description of exemplary embodiments to illustrate the principles of the invention. The embodiments are provided to illustrate aspects of the invention, but the invention is not limited to any embodiment. The scope of the invention encompasses numerous alternatives, modifications and equivalent; it is limited only by the claims.

Numerous specific details are set forth in the following description in order to provide a thorough understanding of the invention. However, the invention may be practiced according to the claims without some or all of these specific details. For the purpose of clarity, technical material that is known in the technical fields related to the invention has not been described in detail so that the invention is not unnecessarily obscured.

### Definitions

The terminology used herein is for the purpose of describing particular embodiments only and is not intended to be limiting of the invention. As used herein, the term “and/or” includes any combinations of one or more of the associated listed items. As used herein, the singular forms “a,” “an,” and “the” are intended to include the plural forms as well as the singular forms, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

The terms “about” and “approximately” shall generally mean an acceptable degree of error or variation for the quantity measured given the nature or precision of the measurements. Typical, exemplary degrees of error or variation are within 20 percent (%), preferably within 10%, and more preferably within 5% of a given value or range of values. Numerical quantities given in this description are approximate unless stated otherwise, meaning that the term “about” or “approximately” can be inferred when not expressly stated.

It will be understood that when a feature or element is referred to as being “on” another feature or element, it can be directly on the other feature or element or intervening features and/or elements may also be present. In contrast, when a feature or element is referred to as being “directly on” another feature or element, there are no intervening features or elements present. It will also be understood that, when a feature or element is referred to as being “connected”, “attached” or “coupled” to another feature or element, it can be directly connected, attached or coupled to the other feature or element or intervening features or elements may be present. In contrast, when a feature or element is referred to as being “directly connected”, “directly attached” or “directly coupled” to another feature or element, there are no intervening features or elements present. Although described or shown with respect to one embodiment, the features and elements so described or shown can apply to other embodiments.

The terms “first,” “second,” and the like are used herein to describe various features or elements, but these features or elements should not be limited by these terms. These terms are only used to distinguish one feature or element from another feature or element. Thus, a first feature or element discussed below could be termed a second feature or element, and similarly, a second feature or element discussed below could be termed a first feature or element without departing from the teachings of the present disclosure.

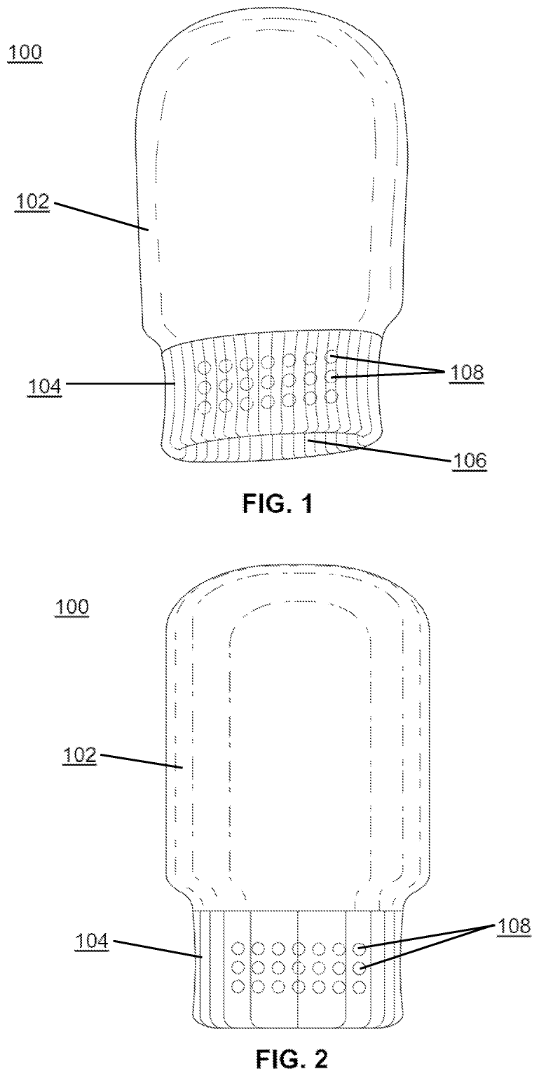

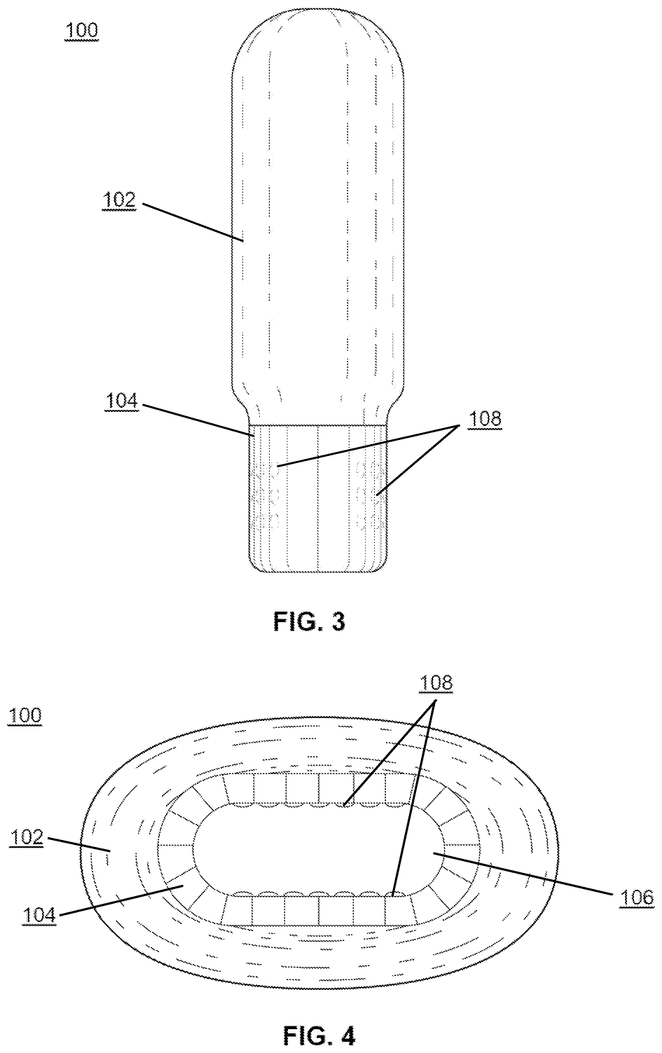

Referring to FIG. 1 through FIG. 4, various isometric views are shown of a first example configuration of a safety cover 100 according to the present disclosure in an unfolded state. The position of the gripping elements 108 on the interior surface of the cuff ring 104 are shown for clarity.

As can be seen, the cover 100 is formed of a fabric cover body 102 with a closed end and an open end, and the open end is attached to the elongated cuff ring 104 to form a glove, mitten, sock, or sheath. The cover body 102 is preferably made of a soft fabric for optimal comfort of the hands or feet of a baby, and may have silver threads woven in to provide antimicrobial properties, since the cover 100 may be applied while a child is sleeping.

As mentioned above, the main purpose of the safety cover 100 is to prevent the child from scratching themselves, and should be difficult to remove, so the cover body 102 is preferably made of a durable or thick material, and without fingers to reduce the dexterity of a baby that wears it.

It is noted that the safety cover 100 could equally well be applied to the paws of pets for similar anti-scratching purposes.

The cuff ring 104 is a ring shape formed of a flexible material and is elastic at least in the direction of its circumference, so that the circumference of opening 106 can easily be expanded to receive the hand or foot of a child and then retract around the ankle or wrist of the child, applying enough elastic tension to stay on them in either a folded or unfolded state.

The cuff ring 104 may be a knitted material, and may be manufactured using a circular knitting technique to create a seamless ring for increased comfort. This also increases the elasticity of the knitted material.

A plurality of gripping elements 108 are arranged around the interior surface of the cuff ring 104, with the arrangement spanning the majority of the length of the cuff ring. The gripping elements 108 should be separate, and should have gaps between them along the circumference, so that they do not impede the expansion of the cuff ring circumference.

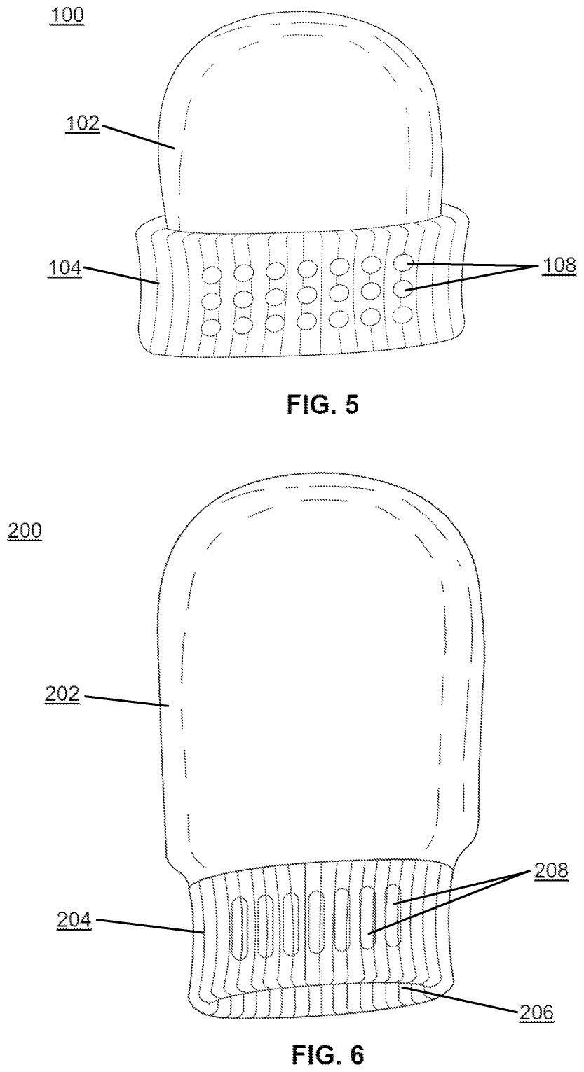

Since the gripping elements 108 span a majority of the length of the cuff ring, and due to its elongated shape, the cuff ring 104 can easily be folded over to disengage the entirety of the gripping elements from skin contact with a baby's wrist or ankle to facilitate easy removal of the cover 100. This folded state is shown in FIG. 5.

The gripping elements 108 provide a certain amount of structural integrity to the cuff ring 104, both in a folded and unfolded state. They may be arranged about the entire circumference or may as shown be divided into opposing arrangements.

In this first example, the gripping elements are small circular silicone grips, with multiple separate rows and columns, however other configurations are possible.

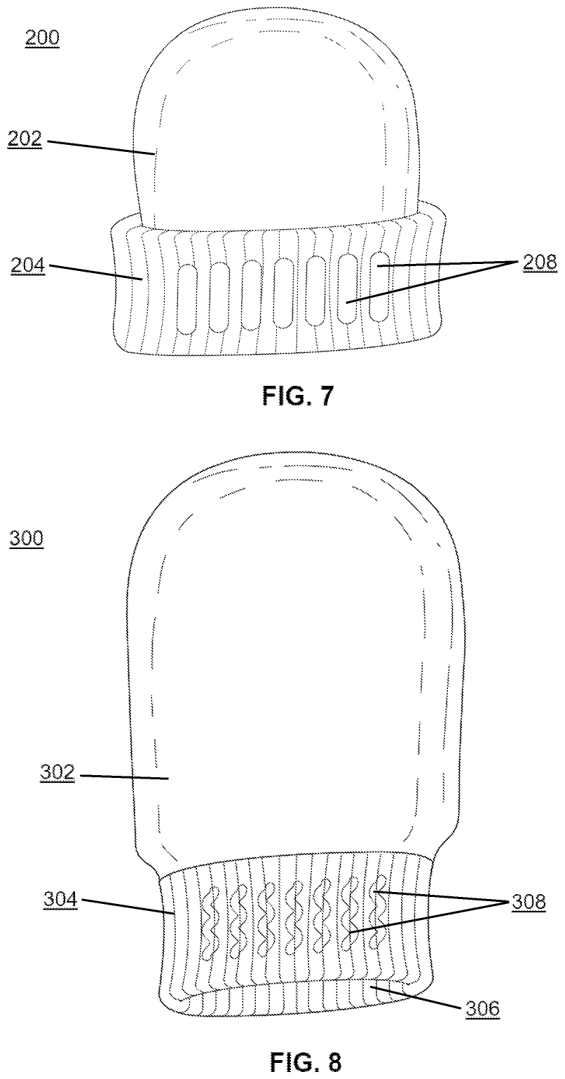

Referring to FIG. 6 and FIG. 7, isometric views are shown of a second example configuration of the cover 200 in unfolded and folded states.

As with the first example, the cover 200 comprises a cover body 202, the cuff ring 204, with an opening 206 for putting the hands and feet into the cover 200, and an alternative arrangement of silicone gripping elements.

In the second example, the gripping elements are in the form of elongated strips that run lengthwise on the cuff ring 104 interior surface, and which have gaps between them about the circumference.

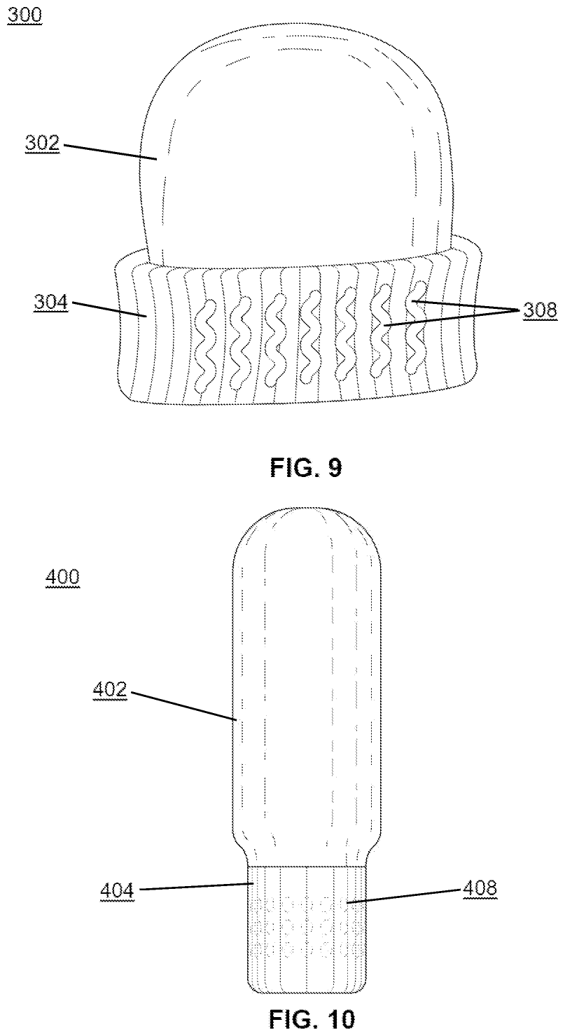

This and many other suitable configurations of the gripping elements are envisioned, including the third example configuration of FIG. 8 and FIG. 9, where the cover 300 has wavy elongated gripping elements 308 disposed about the cuff ring 304. The cover body 302 and the opening 306 are the same once more.

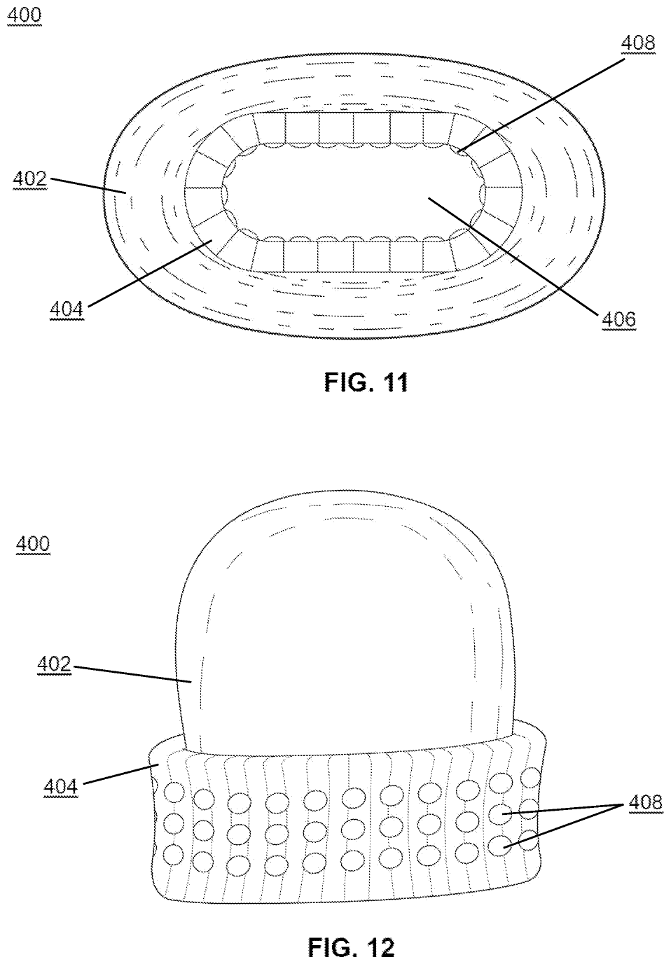

See also FIG. 10, FIG. 11, and FIG. 12 which show a fourth example configuration 400, where the gripping elements 408 are arranged in an array around the cuff 404 in a similar manner to the first example, but in this example the arrangement spans the entire circumference of the cuff 404. Once more, the cover body 402 and the opening 406 are the same once more.

The only restrictions in the arrangement of the gripping elements are that they should span more than half of the length of the cuff ring so that they provide structural integrity in both a folded and unfolded state of the cover, and that they should not overly hinder expansion of the elastic cuff ring about its circumference in a folded or unfolded state.

Unless otherwise defined, all terms (including technical terms) used herein have the same meaning as commonly understood by one having ordinary skill in the art to which this invention belongs. It will be further understood that terms, such as those defined in commonly used dictionaries, should be interpreted as having a meaning that is consistent with their meaning in the context of the relevant art and the present disclosure and will not be interpreted in an idealized or overly formal sense unless expressly so defined herein.

The disclosed embodiments are illustrative, not restrictive. While specific configurations of the system and method have been described in a specific manner referring to the illustrated embodiments, it is understood that the present invention can be applied to a wide variety of solutions which fit within the scope and spirit of the claims. There are many alternative ways of implementing the invention.

It is to be understood that the embodiments of the invention herein described are merely illustrative of the application of the principles of the invention. Reference herein to details of the illustrated embodiments is not intended to limit the scope of the claims, which themselves recite those features regarded as essential to the invention.

What is claimed is:

1. A wearable safety cover, comprising:
a cover body formed of a flexible fabric material and having a first open end and a second closed end;
an elongated cuff ring coupled to the first open end of the cover body, the cuff ring being formed of an elastic material arranged so as to allow stretching of the cuff ring circumference; and
an arrangement of separate gripping elements disposed about the circumference of an interior surface of the elongated cuff ring, the arrangement of gripping elements spanning a majority of the length of the elongated cuff ring.

2. A wearable safety cover according to claim 1, wherein the gripping elements are attachments formed of a material having a greater friction coefficient than the material forming the cuff ring.

3. A wearable safety cover according to claim 1, wherein gripping elements are silicone attachments.

4. A wearable safety cover according to claim 1, wherein the arrangement of gripping elements forms an array with multiple rows of gripping elements spanning the length of the cuff ring interior surface.

5. A wearable safety cover according to claim 1, wherein the gripping elements each have an elongated shape oriented such that their lengths are aligned with the length of the elongated cuff ring.

6. A wearable safety cover according to claim 1, wherein the arrangement of gripping elements spans the entire circumference of the interior surface of the cuff ring.

7. A wearable safety cover according to claim 1, wherein the arrangement of gripping elements is divided into two or more arrangements disposed on opposing portions of the circumference of the interior surface of the cuff ring.

8. A wearable safety cover according to claim 1, wherein the cuff ring has been knitted using a circular knitting technique to form a seamless circumference.

9. A wearable safety cover according to claim 1, wherein the cuff ring and/or cover body have silver threads woven for an antimicrobial effect.
